(19) United States
(12) Patent Application Publication
(10) Pub. No.: US 2016/0012181 A1
(43) Pub. Date: Jan. 14, 2016

(54) METHOD FOR ASSIGNING A QUALITATIVE IMPORTANCE OF RELEVANT GENETIC PHENOTYPES TO THE USE OF SPECIFIC DRUGS FOR INDIVIDUAL PATIENTS BASED ON GENETIC TEST RESULTS

(71) Applicant: ELEVATED CAPITAL GROUP LLC, MANDEVILLE, LA (US)

(72) Inventors: BILL W. MASSEY, HEBER SPRINGS, AR (US); RICHARD ZIMMER, III, MANDEVILLE, LA (US); JASON MONEY, FRISCO, TX (US); CHRISTOPHER ST. PIERRE, FAIRHOPE, AL (US)

(73) Assignee: ELEVATED CAPITAL GROUP LLC

(21) Appl. No.: 14/795,500

(22) Filed: Jul. 9, 2015

Related U.S. Application Data
(60) Provisional application No. 62/023,439, filed on Jul. 11, 2014.

(51) Int. Cl. G06F 19/24; G06F 19/00

(52) U.S. Cl. CPC G06F 19/24; G06F 19/3487; G06F 19/325

(57) ABSTRACT

The present invention is a method for assigning a qualitative importance of relevant genetic phenotypes to the use of specific drugs for individual patients based on genetic test results. The invention provides a drug-centric integration of pharmacogenetic test information across multiple genes relevant to an individual drug. The invention then assigns a color designation for each drug reported and groups the drugs together on a report according to drug class/therapeutic area, thus allowing the physician to easily and quickly identify a drug from a specific drug class that would be best for that patient according to their entire pharmacogenetic test results. The outputs of the method can be added to existing pharmacogenetic test reports as a quick guide for the physician. Such integration of pharmacogenetic information from multiple genes and drug-centric organization of the outputs should allow physicians to more easily utilize and incorporate pharmacogenetic testing into their practice.

### BACKGROUND OF THE INVENTION

This application claims priority from U.S. Provisional Application No. 62/023,439 (the '439 application), filed Jul. 11, 2014. The '439 application is incorporated herein by reference

Pharmacogenetics involves the use of genetic information from an individual patient to inform drug selection. This rapidly emerging field has shown great promise in improving outcomes from pharmacotherapy by identifying genetic variants of genes known to affect drug metabolism and drug response. FDA has also noted the importance of pharmacogenetics by including pharmacogenetic information relevant to the safe and effective use of individual drugs into the drug's labeling. The number of drugs for which pharmacogenetic information is included in the product labeling currently stands at over 100, but that number is rapidly expanding.

Physicians are beginning to learn about pharmacogenetic testing and are struggling to keep abreast of this new field. Currently offered pharmacogenetic testing is conducted by obtaining a patient sample (e.g. blood, saliva, etc.), testing that sample for known variants in genes that are associated with drug response, and then issuing a test report that outlines the results according to the patient's genoptypes for the tested genes/gene variants, along with the associated phenotypes (i.e. the biological consequence of the genotypes). Usually, the pharmacogenetic test report lists each gene/genotype/phenotype separately and usually include a list of drugs affected by each gene, so that the physician can look at the information and make an optimal drug selection for this patient. However, many physicians find the test reports confusing and are having difficulty in incorporating this information into their usual practice of medicine. Some of the reasons for this difficulty are general lack of knowledge of genetics and pharmacogenetics in particular, time constraints related to their daily patient volumes, and the necessity to look at and integrate multiple sections of the report related to the different genes tested and their significance for a particular drug.

### SUMMARY OF THE INVENTION

The present invention described herein eliminates these issues noted above by providing a drug-centric integration of the pharmacogenetic test information across multiple genes relevant to an individual drug. The method then assigns a color designation for each drug reported and groups the drugs together on the report according to drug class/therapeutic area, thus allowing the physician to easily and quickly identify a drug from a specific drug class that would be best for that patient according to their entire pharmacogenetic test results. It is anticipated that the outputs of the method can be added to existing pharmacogenetic test reports as a quick guide for the physician. Such integration of pharmacogenetic information from multiple genes and drug-centric organization of the outputs should allow physicians to more easily utilize and incorporate pharmacogenetic testing into their practice. The method is easily updated to include new genetic findings, new genes, additional drugs, and any new science that is relevant to the reported drugs.

The inventive method utilizes phenotypic results of individual patients obtained from genetic testing of genes that influence drug metabolism and innate drug response (both therapeutic and adverse responses). The inventive method determines the clinical relevance of response and metabolic gene phenotypes and integrates these into a qualitative importance assignment to specific drugs. The qualitative importance assignment is represented by color-coding of each specific drug into: Green (no genetic indicators of clinical importance found); Yellow (genetic indicators found that warrant extra caution); and Red (genetic indicators found that warrant extreme caution or avoidance). The color-coding of a specific drug, termed its Phenotypic Color Designation (PCD), is assigned based on the resultant PCD value as determined by the invention and described in the DETAILED DESCRIPTION OF THE INVENTION below.

It is an object of this invention to prepare a drug-centric combinatorial pharmacogenetic guidance report for a patient, that color-codes the drugs based on the risk designations resultant from the output of the method, and arranges the drugs by drug class for ease of comparison and drug selection by a physician.

Qualitative importance assignment is determined by individual assessment of metabolic gene phenotypes, which are calculated into a Drug Score Metabolic Component Value (hereafter referred to as “MCV”), and a separate calculation of the response/adverse effect phenotypes as a Drug Score Response Component Value (hereafter referred to as “RCV”). The specific qualitative importance assignment for each specific drug is made based on the greater score between the MCV and RCV. In other words, if the RCV is greater than the MCV, then the drug is coded to reflect the RCV value, and vice versa.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIGS. 1a through 1j illustrate an example pharmacogenetic report reflecting the results of the inventive method as applied to an individual patient.

FIG. 1a is the cover sheet of the example pharmacogenetic report and lists the genotypes and associated phenotypes for a number of genes that code for drug metabolizing enzymes and drug response/adverse effect proteins for a fictitious patient.

FIGS. 1b and 1c, pages 2 and 3 of the example pharmacogenetic report respectively, illustrate the phenotypic color designations for specific individual drugs grouped according to drug class and therapeutic area. The color designations shown for these individual specific drugs are the outputs of the inventive method.

FIGS. 1d through 1j, pages 4 through 10 of the example pharmacogenetic report respectively, provide further descriptive information regarding the clinical relevance of the fictitious patient's phenotypes and the tested genes.

FIGS. 2a through 2m is a spreadsheet that shows the invention and its use in producing the example report of FIGS. 1a through 1j.

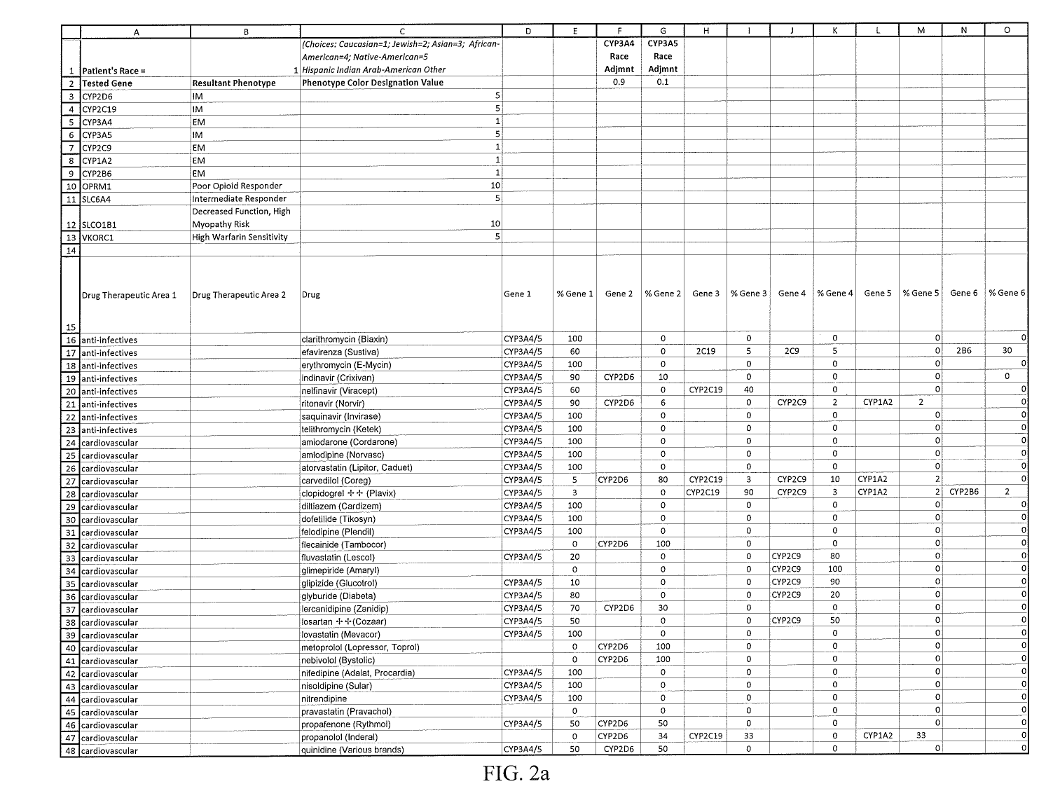

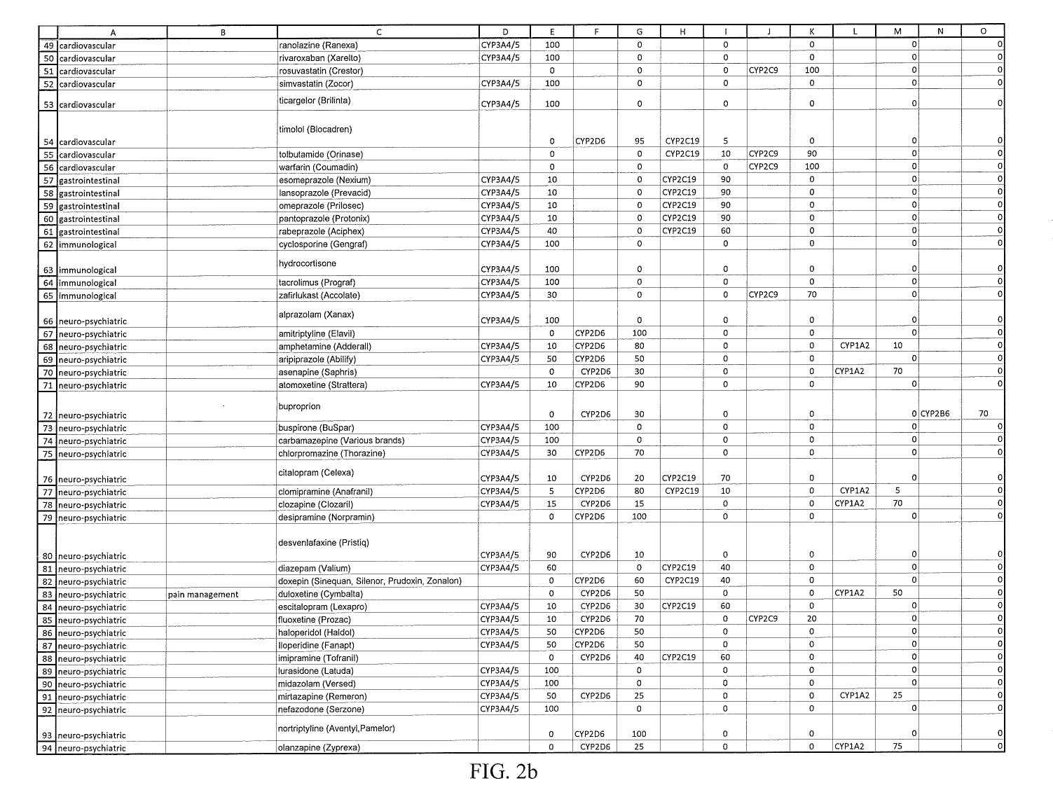

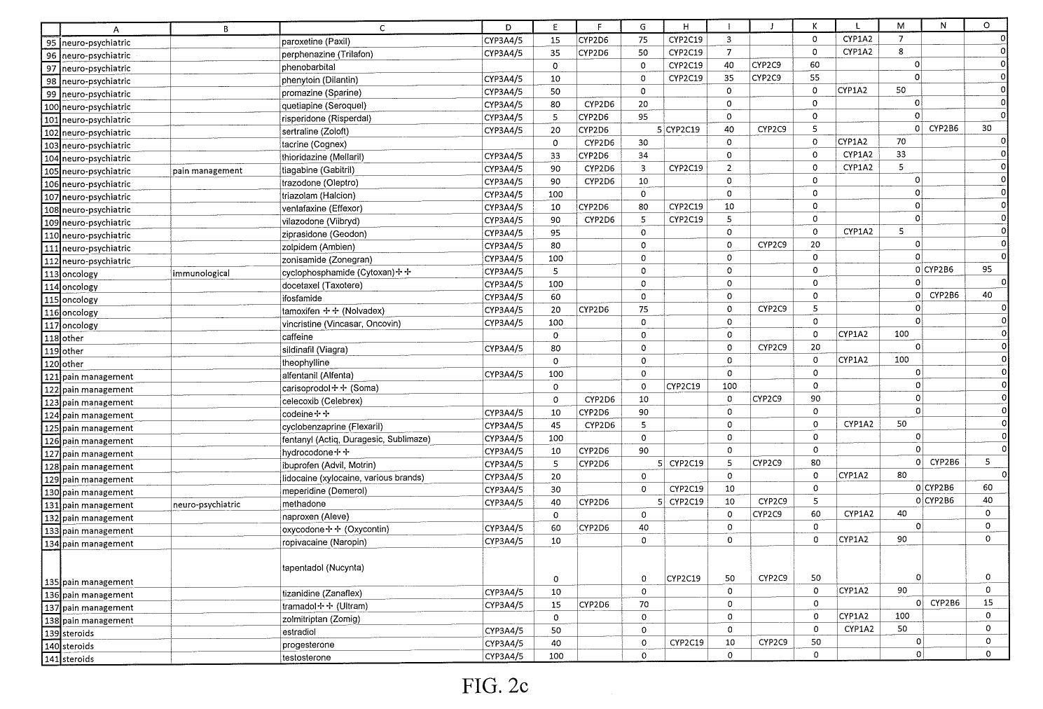

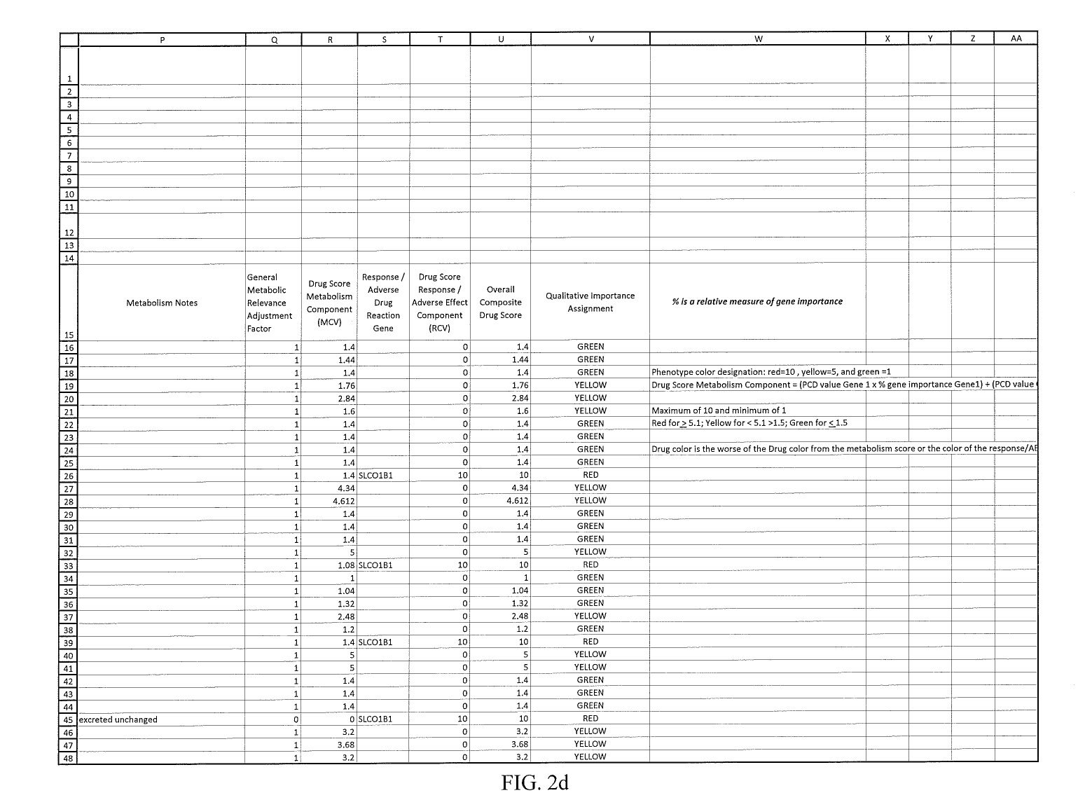

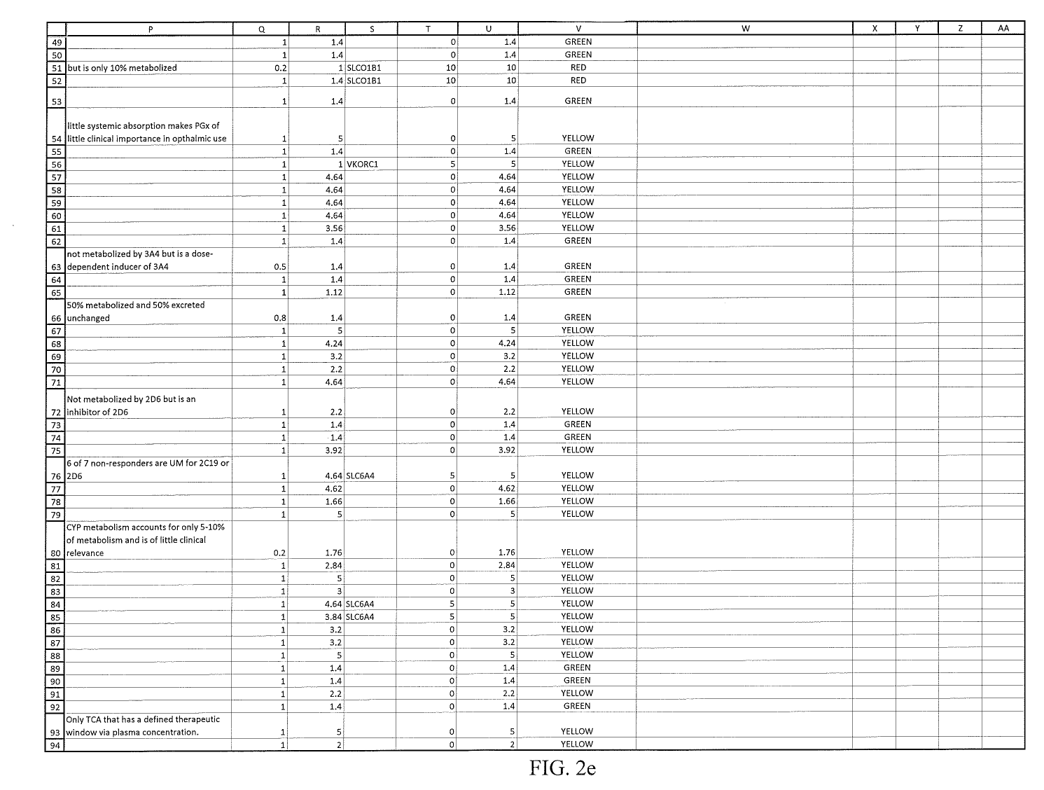

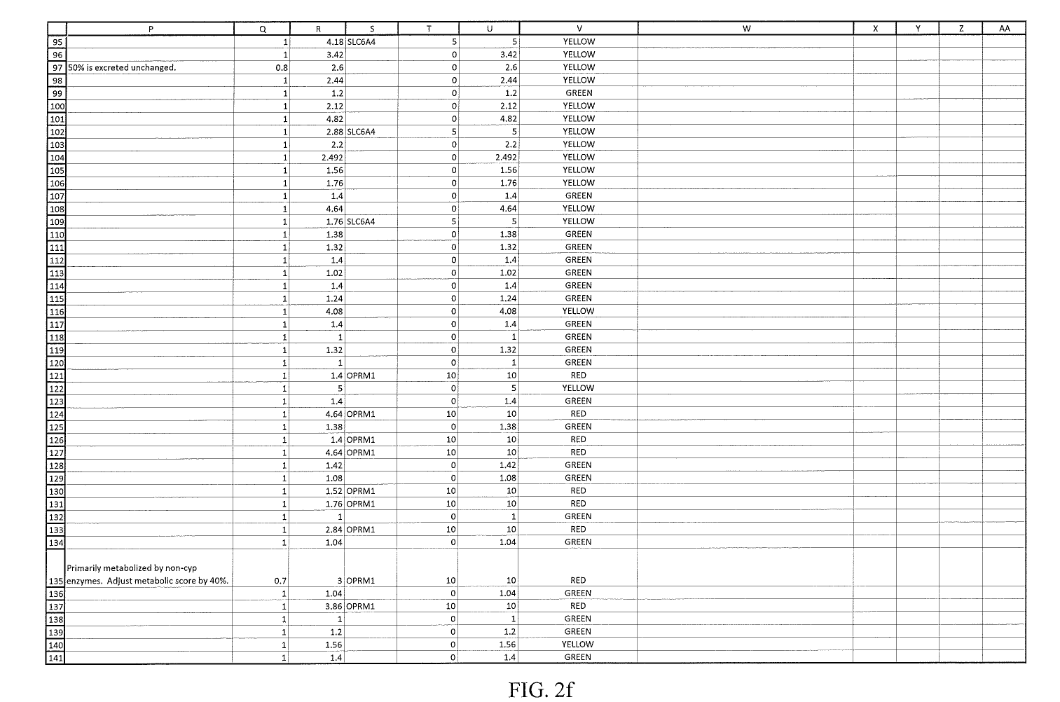

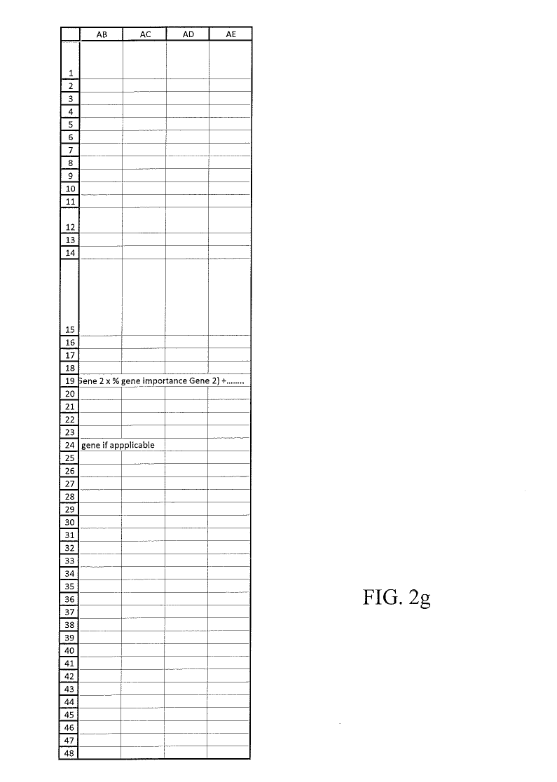

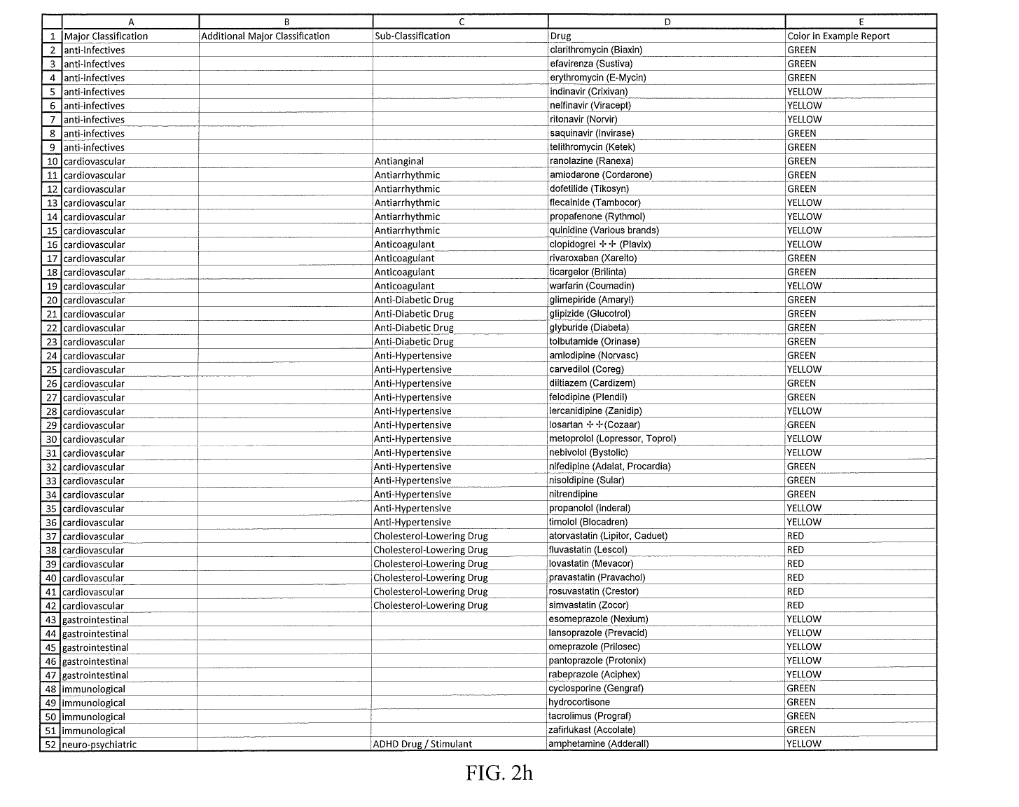

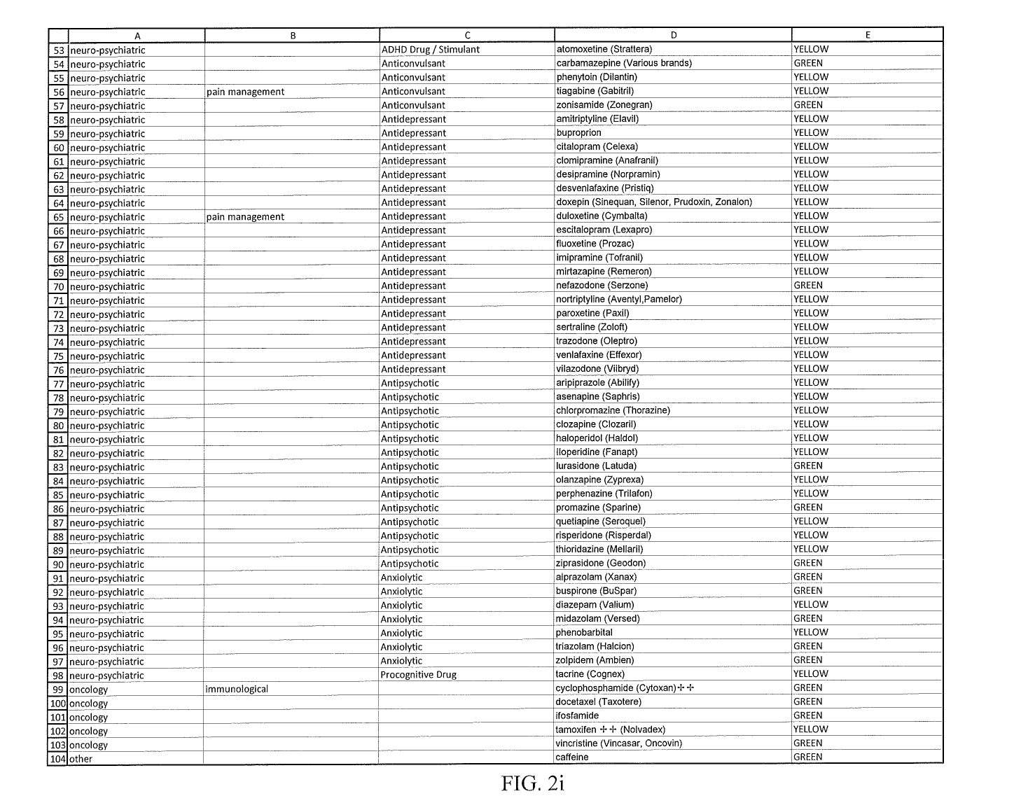

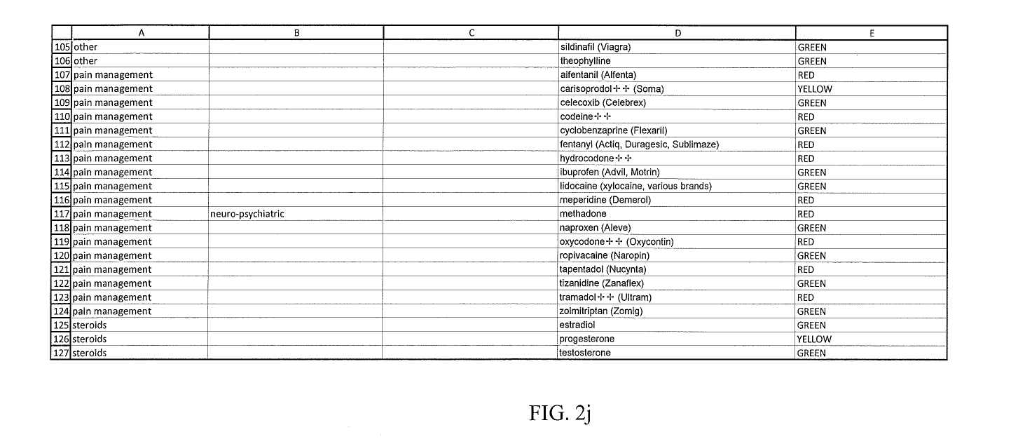

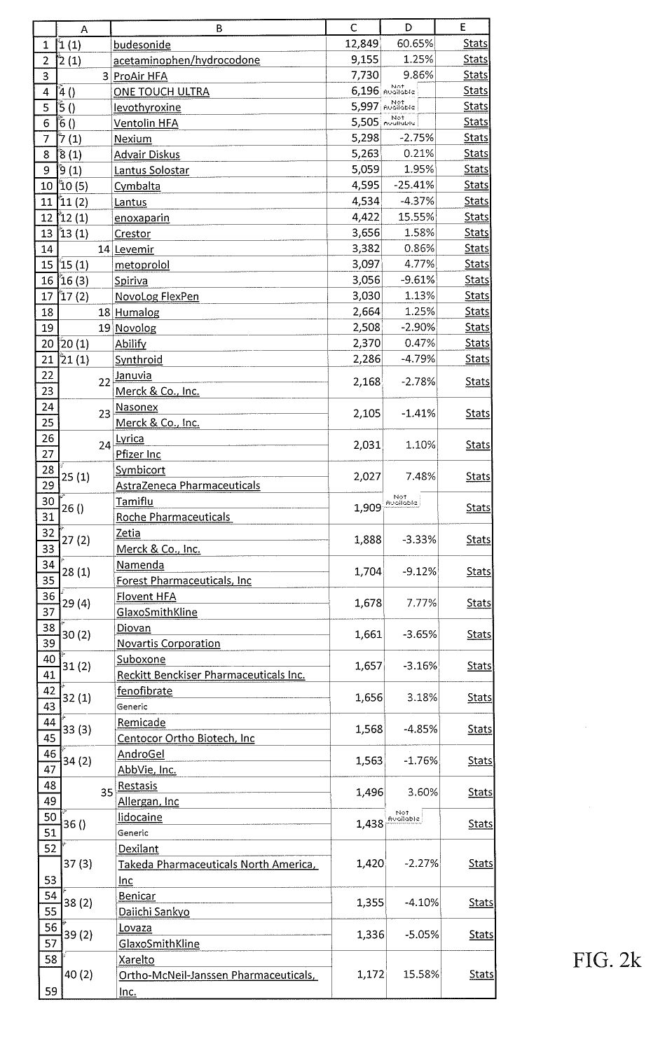

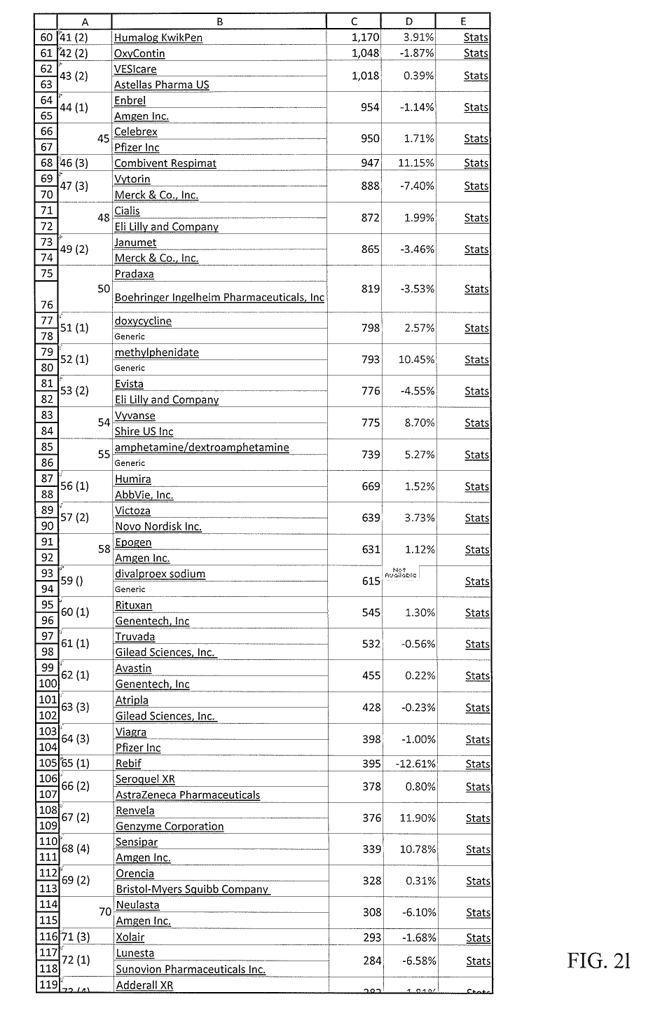

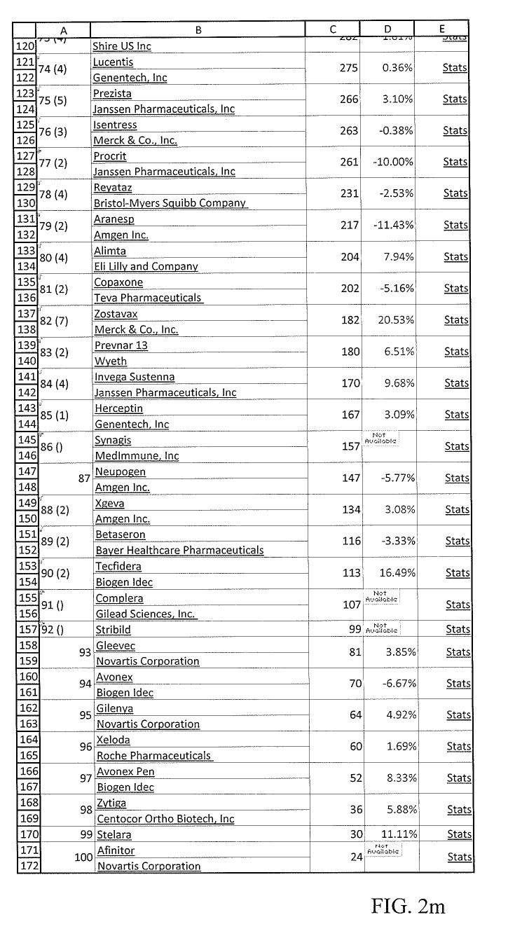

In FIG. 2a the phenotypes for each gene tested and patient's race are entered into the spreadsheet's upper left-hand corner (cells B3 through B13 for the phenotypes and cell B1 for race) and these inputs are subjected to the calculations that yield the MCV and RCV for each of the drugs evaluated.

In FIGS. 2a to 2g, the drugs evaluated, the genes relevant to each specific drug, each relevant gene's metabolic % relative importance value, and the equations and logical operators that calculate the PCD values are shown on rows 16 through 141.

In FIGS. 2d to 2f, the end result of the calculations and logical operators, the PCD, is shown in column V.

In FIGS. 2h to 2j, the color designation used in the example pharmacogenetic report is shown by classification and drug.

FIGS. 2k to 2m are offered as a reference listing the top 120+ drugs by prescriptions in the US for a recent quarter, and picked for use in the example pharmacogenetic report.

### DETAILED DESCRIPTION OF THE INVENTION

As noted above, the specific qualitative importance assignment for each specific drug is made based on the greater score between the MCV and RCV.

The metabolic component is the most complex assessment and the method of assessment is described as follows:

1) The relative clinical importance of each tested gene's phenotype was assigned by subjective determination of clinical relevance and assigned a % relevance value that sums to 100% across all tested relevant genes. The following pharmacological and toxicological attributes of each drug's metabolism were considered when assigning a % relevance value:
a) the overall contribution of each tested gene to the total metabolism of the drug and resultant drug metabolites. This measure forms the basis for the % relevance of each gene involved, but is modified to reflect the impact of the following influences in b), c), and d);
b) the clinical relevance of the metabolic product from each tested gene (e.g. active metabolite, toxic metabolite, primary to drug response (e.g. pro-drugs); and
c) known pharmacogenetic-related metabolic effects from the FDA-approved labeling.
d) relevant information from the scientific literature (e.g. in vitro studies using human hepatocytes, clinical studies, etc.

The above information was obtained by examination of the FDA-approved labeling and by a literature search and review based on googling the search terms “drug name cyp metabolism”. A detailed review of the known effects of the metabolic genes tested was then used to assess their relative importance in respect to their biochemical, physiological, and pharmacological effects as these pertain to clinical safety and efficacy as per the drug/metabolite attributes listed above. In all cases the guiding maxim was “first, do no harm”.

A bifurcated calculation based upon racial identification (African descent versus non-African descent) was employed for assigning clinical relevance to CYP3A4 and CYP3A5 metabolic status, as African ancestry indicates predominantly CYP3A5 activity and non-African ancestry indicates predominantly CYP3A4 activity according to a 10%/90% bifurcated assignment.

In addition, a general metabolic relevance adjustment factor (%) was applied to the MCV when appropriate, such as for a drug that is only minimally metabolized and excreted unchanged.

The MCV was calculated by the following equation:

Drug Score Metabolism Component=(PCD value Gene 1×% gene importance Gene1) +(PCD value Gene 2×% gene importance Gene 2) +. . . and so on.

Phenotype color designation value (PCD): Red=10, Yellow=5, and Green=1 The equation can result in a maximum MCV of 10 and minimum MCV of 1. The qualitative importance assignment is made by comparing the MCV to the following scale ranges:

Red for≧5.1; Yellow for<5.1>1.5; Green for≦1.5

### EXAMPLES

Example: Sustiva (metabolized by tested genes CYP3A4/5, CYP2B6, CYP2C9, and CYP2C19) in a Caucasian patient that had the following results: 3A4 PM, 3A5 IM, 2B6 EM, 2C9 IM, 2C19 PM

MCV=((10*0.60)*0.9)+((5*0.60)*0.1)+(1*0.30)+(5*0.05)+(10*0.05)=6.75

Thus, for the above example for Sustiva, the MCV=6.75, or a red phenotypic color designation for Sustiva in this patient. Since no response/adverse event markers relevant to Sustiva were tested, there is no RCV and thus the MCV is the sole determinant of the phenotypic color designation for Sustiva.

Example: Simvastatin (metabolized by tested genes CYP3A4/5 in a patient of African descent and the adverse effect gene SLCO1B1 for myopathy risk) that had the following results: 3A4 IM, 3A5 EM, SLCO1B1 Intermediate function.

MCV=((5*1.0)*0.1)+((1*1.0)*0.9)=1.4=Green

RCV=5=Yellow

(SLCO1B1 is specific for statins and no other relevant response marker is tested)
Thus, for the above example of simvastatin, the MCV=1.4 and the RCV=5, therefore the phenotypic color designation for simvastatin in this patient is determined by the greater value RCV=5, or Yellow.

The next example, desvenlafaxine, is one that employs a general metabolic relevance factor since desvenlafaxine is only metabolized 5-10% by CYP enzymes.

Example: Desvenlafaxine (metabolized by tested genes CYP3A4/5 and CYP2D6 in a patient of non-African descent) that had the following results: 3A4 EM, 3A5 PM, and 2D6 EM. Note that SLC6A4 is not included as a relevant response marker for desvenlafaxine since desvenlafaxine is a SNRI, not an SSRI.

MCV=((1*0.9)*0.9)+((10*0.9)*0.1)+(1*0.1)=1.81*0.10 (the general metabolic relevance factor)=0.18=Green

Thus for the above example of desvenlafaxine, the MCV=0.18 (after adjusting for general metabolic relevance)=Green (since there are no relevant response/adverse effect markers, the MCV is the sole determinant of the phenotypic color designation).

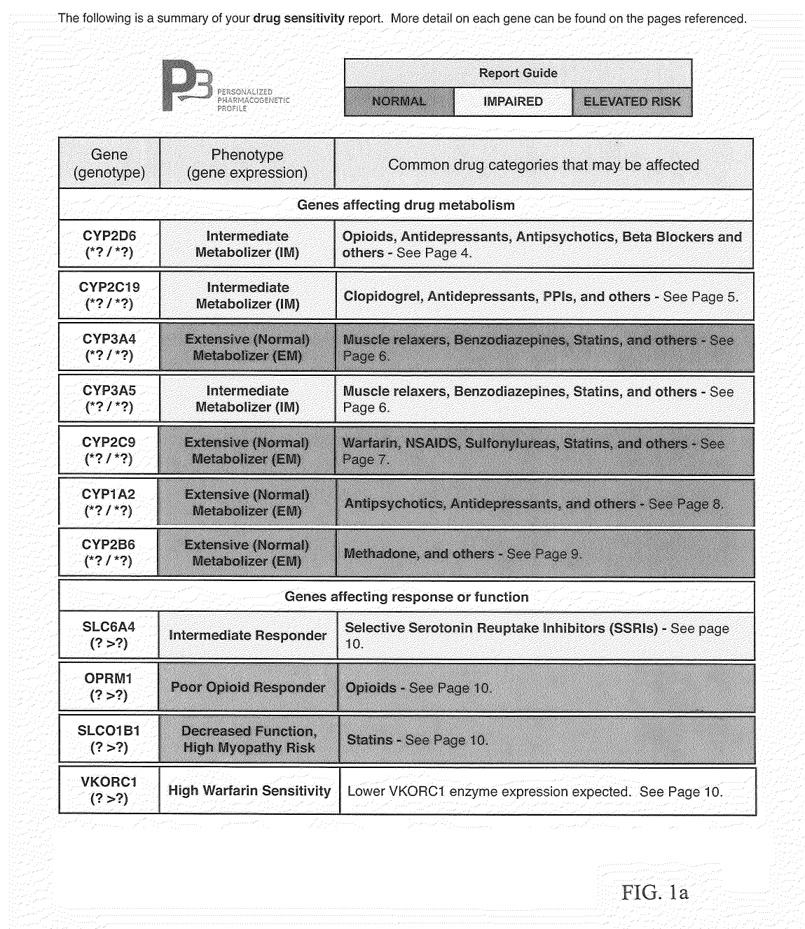

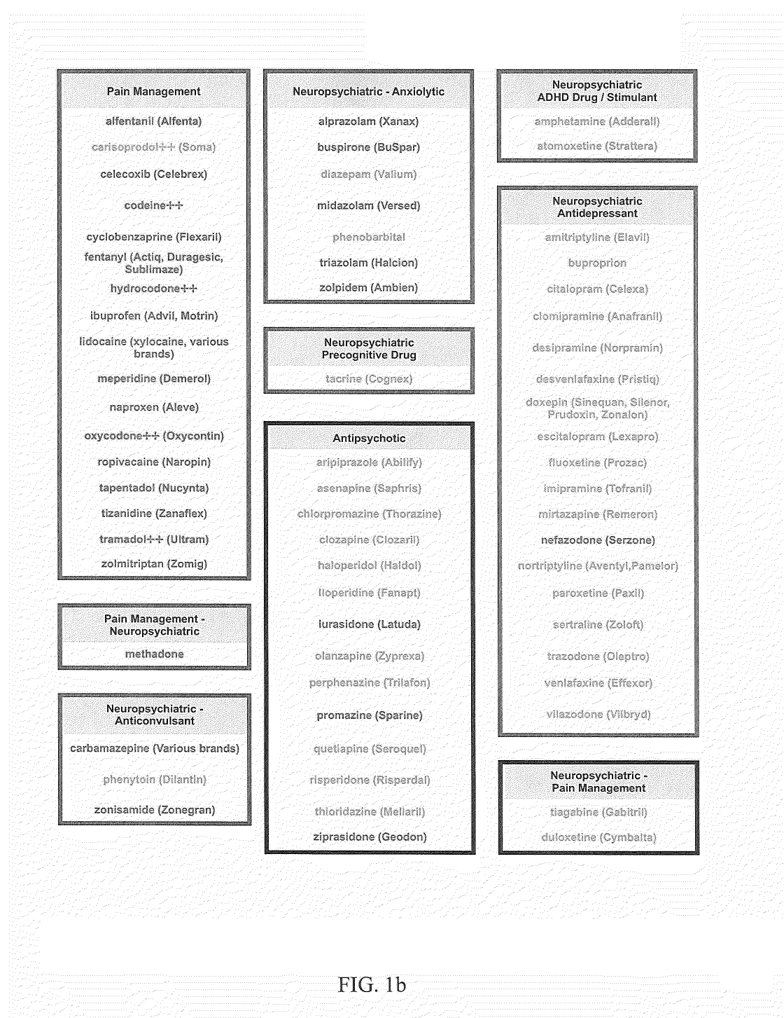

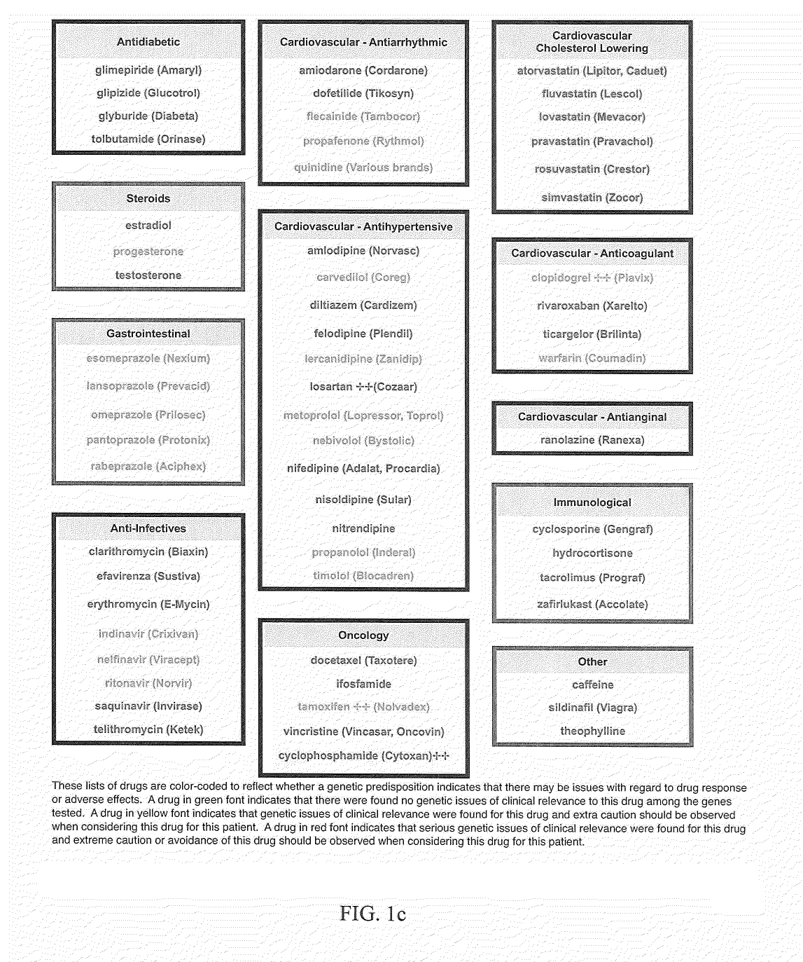

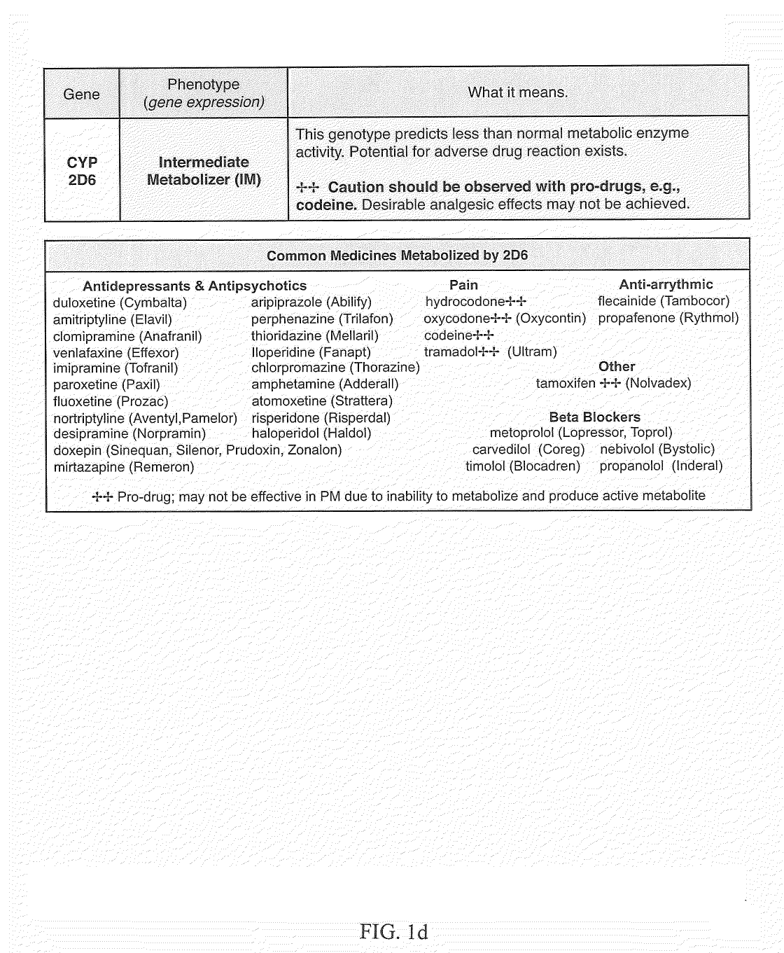

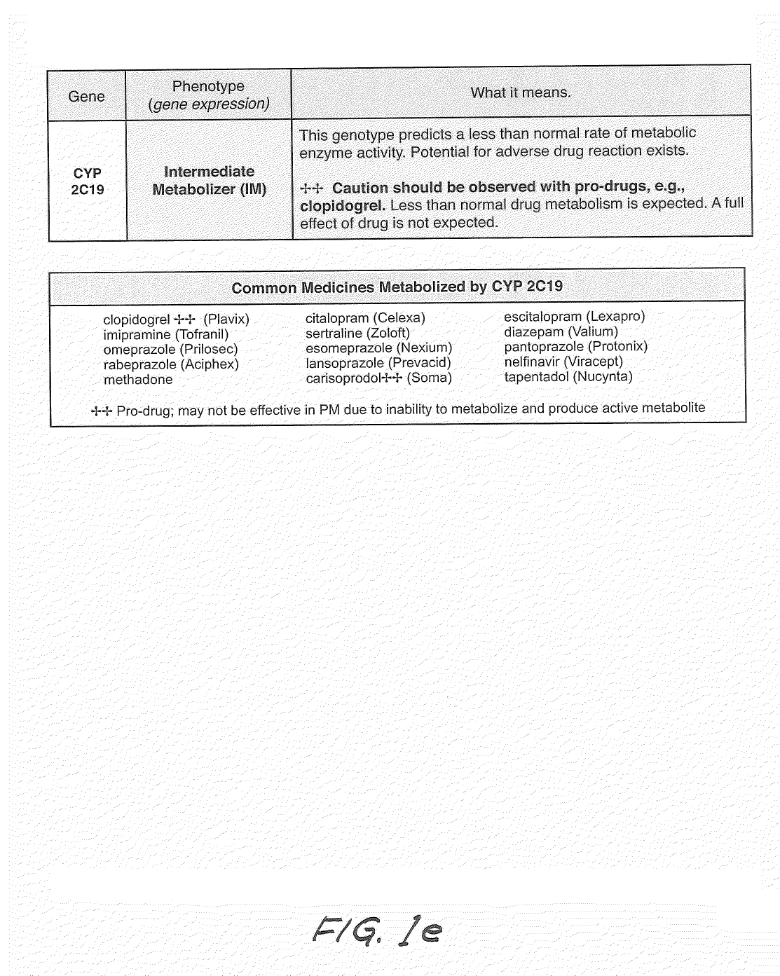

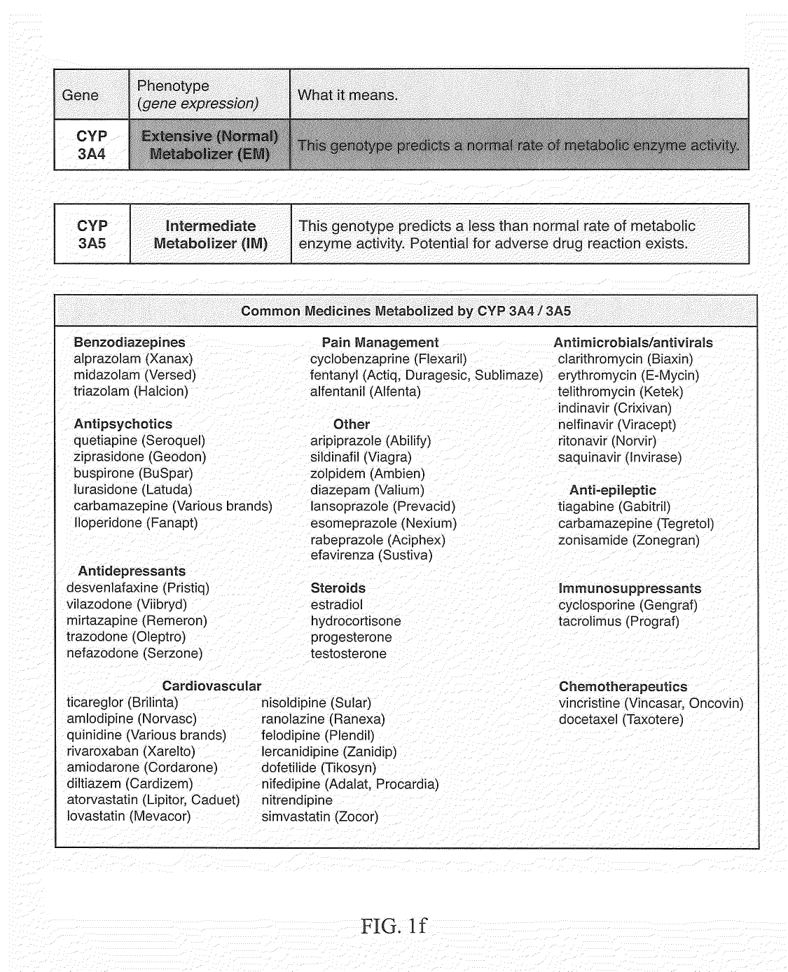

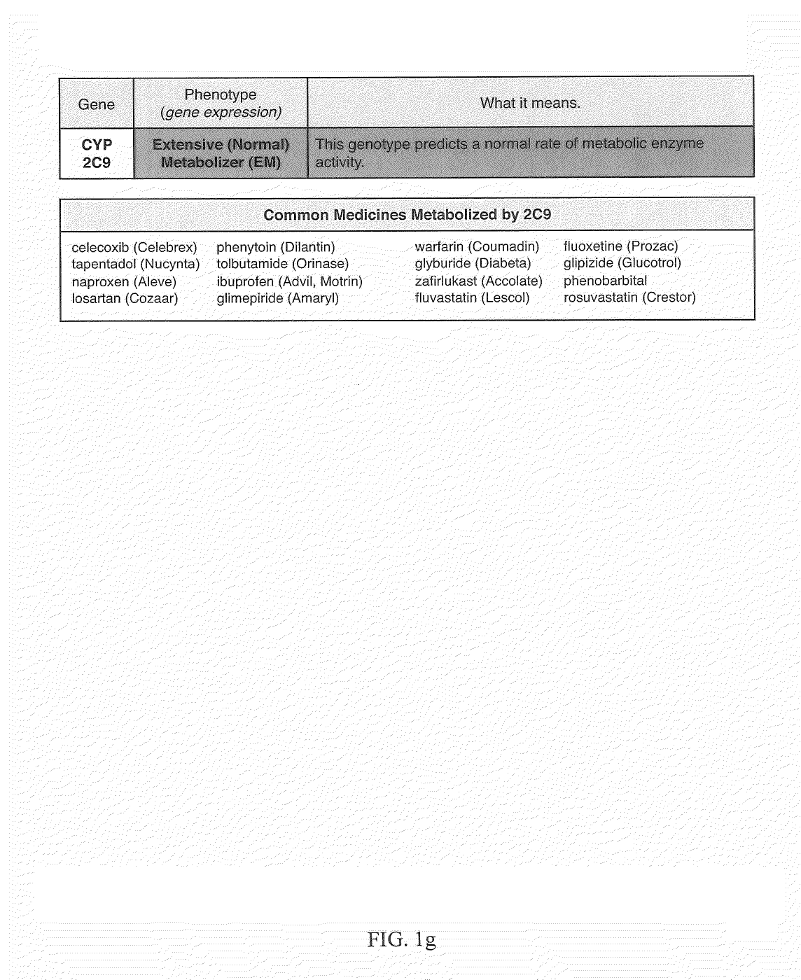

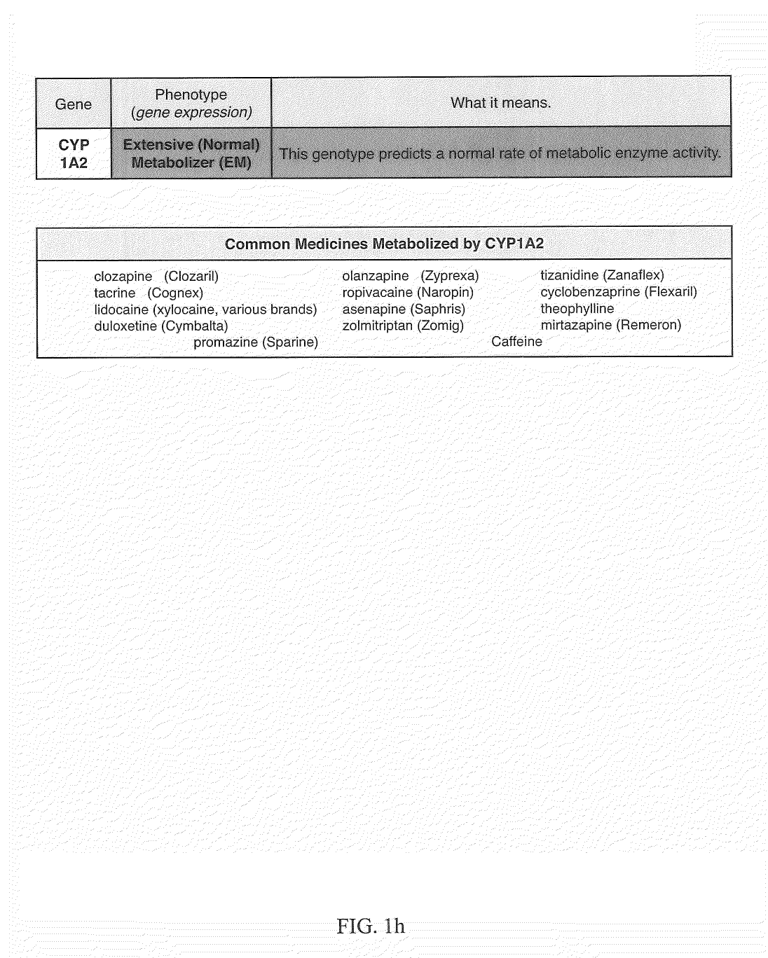

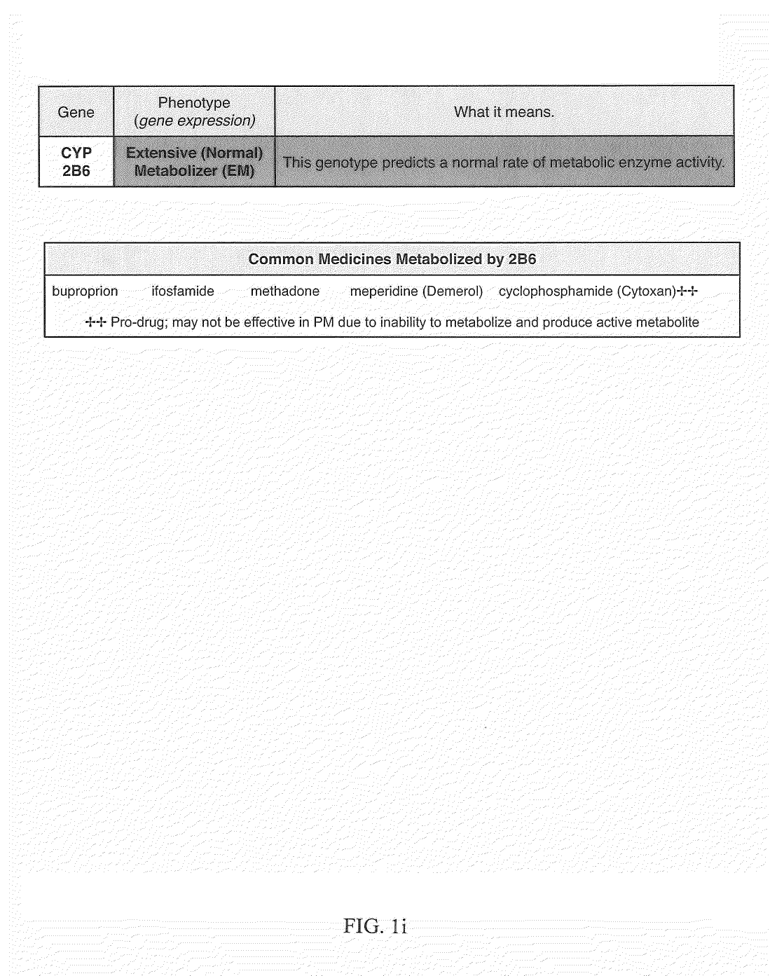

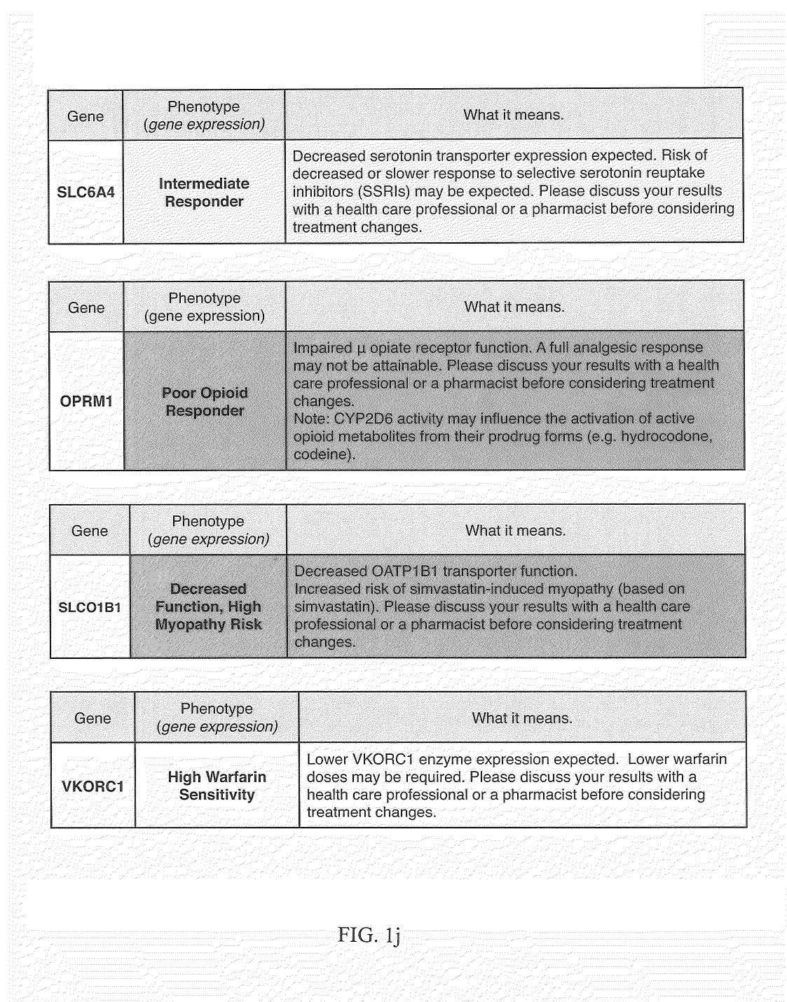

Referring now to FIGS. 1a through 1j, which represent an example test report that includes the outputs of the invention (i.e. the phenotypic color designation) for a list of commonly prescribed drugs, showing how the invention can be incorporated into a pharmacogenetic test report. On FIG. 1a, page 1 of the example pharmacogenetic test report, are listed the genotypes and associated phenotypes for a number of genes that code for drug metabolizing enzymes and drug response/adverse effect proteins for a fictitious patient. The phenotypes for each of the tested genes, along with whether the patient is of African or Non-African descent are the inputs required by the invention to determine phenotypic color designations for the drugs shown on FIGS. 1b and 1c, pages 2-3 of this example report. In this example report, the color-coded drugs are grouped according to drug class and therapeutic area to facilitate ease of use for the pharmacogenetic information by the physician in making a drug selection. FIGS. 1d through 1j, pages 4 through 10 of the example pharmacogenetic report respectively, provide descriptive information regarding the clinical relevance of the fictitious patient's phenotypes and the tested genes and is not a product of the invention.

FIGS. 2a through 2m is a spreadsheet that shows the invention and its use in producing the example report of FIGS. 1a through 1j. In FIG. 2a the phenotypes for each gene tested and patient's race are entered into the spreadsheet's upper left-hand corner (cells B3 through B13 for the phenotypes and cell B1 for race) and these inputs are subjected to the calculations that yield the MCV and RCV for each of the drugs evaluated. In FIGS. 2a to 2g, the drugs evaluated, the genes relevant to each specific drug, each relevant gene's metabolic % relative importance value, and the equations and logical operators that calculate the PCD values are shown on rows 16 through 141. Each row is specific for a particular drug and the end result of the calculations and logical operators, the PCD, is shown in column V in FIGS. 2d to 2f In FIGS. 2h to 2j, the color designation used in the example pharmacogenetic report is shown by classification and drug. These PCDs are then converted into colored font text on the example report on pages 2 and 3, FIGS. 1b and 1c.

We claim:

1. A method for assigning a qualitative importance of relevant genetic phenotypes to the use of specific drugs for individual patients based on genetic test results, comprising the following steps:
a. genetically testing a patient for CYP genes that influence drug metabolism and effector genes that affect drug response, each gene having a phenotype assigned with a phenotype color designation value of Red equal to 10 indicating that found genetic indicators warrant extreme caution or avoidance, Yellow equal to 5 indicating that found genetic indicators warrant extra caution, or Green equal to 1 indicating that no genetic indicators of clinical importance found;
b. for a specific drug, assign a percentage of clinical relevance to each CYP gene tested, the percentage being based upon the portion of a dose of the drug that is metabolized via each gene-controlled pathway and the percentage adjusted based upon the relevance of the metabolic process to the safety and/or efficacy of the drug per FDA guidance and the peer-reviewed scientific literature, which percentage sums to 100 percent for all CYP genes tested;
c. calculate a metabolic component value for that drug as follows:
metabolic component value=(phenotype color designation for first CYP gene×percentage of clinical relevance for first CYP gene)+(phenotype color designation for second CYP gene×percentage of clinical relevance for second CYP gene)+(phenotype color designation for third CYP gene×percentage of clinical relevance for third CYP gene)+similar sum for each remaining gene;
d. where applicable, calculate a response component value for that drug as done for the metabolic component value;
e. using the greater of the metabolic component value or the response component value for the drug, designate a phenotypic color to the drug as follows:
Red for greater than or equal to 5.1,
Yellow for less than 5.1 and greater than 1.5,
Green for less than or equal to 1.5;
f. prepare a drug-centric combinatorial pharmacogenetic guidance report for the patient, that color-codes the drugs based on the risk designations resultant from the output of the method, and arranges the drugs by drug class for ease of comparison and drug selection by a physician.

2. The method of claim 1 where the tested CYP genes that influence drug metabolism comprise CYP2D6, CYP2C19, CYP3A4, CYP3A5, CYP2C9, CYP1A2, CYP2B6, and the tested genes that affect drug response comprise SLC6A4, OPRM1, SLCO1B1, and VKORC1.

3. The method of claim 2 where the tested CYP genes that influence drug metabolism and the tested genes that affect drug response further comprise other CYP genes and non-CYP metabolic genes as supported in emerging scientific evidence.

4. The method of claim 1 for assigning a qualitative importance of relevant genetic phenotypes to the use of specific drugs for individual patients based on genetic test results, further comprises a bifurcated calculation based upon racial identification of African descent versus non-African descent by using a 10%/90% bifurcated assignment of clinical relevance to CYP3A4 and CYP3A5 metabolic status, as African ancestry indicates predominantly CYP3A5 activity and non-African ancestry indicates predominantly CYP3A4 activity.
